(19) United States
(12) Patent Application Publication
(10) Pub. No.: US 2009/0107051 A1
(43) Pub. Date: Apr. 30, 2009

(54) CLOSURE MECHANISM

(76) Inventor: Joseph Talpe, Avelgem-Kerkhove (BE)

Correspondence Address: SUGHRUE MION, PLLC, 2100 PENNSYLVANIA AVENUE, N.W., SUITE 800, WASHINGTON, DC, 20037, US

(21) Appl. No.: 11/926,223

(22) Filed: Oct. 29, 2007

(51) Int. Cl. E05F 3/00; E06B 11/04

(52) U.S. Cl. 49/386; 16/64

(57) ABSTRACT

A closure mechanism C comprising a elongated push/pull member 1, a base part 2, a resilient element 4, such as a coil spring, a motion converting means 6, such as a rack-and-pinion gearing, comprising a rotary output element 6o and a rotary braking device 7, such as a centrifugal brake, comprising a rotary input element 7i directly or indirectly coupled to said rotary output element 6o at least during movement of the elongated push/pull member 1 towards said first position, so as to be rotated thereby. The elongated push/pull member 1 and the base part 2 are assembled to each other so that said elongated push/pull member 1 is guided in a translational motion relative to the base part 2 between a first and a second position. The resilient element 4 is placed between said first and base parts 1, 2 so as to urge the elongated push/pull member 1 towards said first position. The motion converting means 6 converts the translational motion of said elongated push/pull member 1 relative to said base part 2 into a rotational motion of said rotary output element 6o, which is transmitted to the rotary input element 7i, and the rotary braking device 7 brakes its rotary input element 7i with a variable braking torque which increases and decreases with the rotational speed of said rotary input element 7i.

The present invention relates to a closure mechanism for members hinged to structures as defined in the preamble of claim 1.

The closure mechanism defined in the preamble of claim 1 comprises more particularly an elongated push/pull member and a base part, each one of them attachable to one of the hinged member or structure, guided relative to each other in a linear translational motion between a first and a second position and urged towards a first position wherein the hinged member is closed by a resilient element interposed between them. The closure mechanism is of the type wherein the distance between attachment points of the elongated push/pull member and the base part to the hinged member and the structure varies upon opening or closing of the hinged member not by a relative rotational motion of both parts with respect to one another but by a translational motion.

Such linearly extendable and contractible closure mechanisms are generally known in the art and are used especially for outdoor applications such as for garden gates and doors. Usually, to avoid slamming, these closure mechanisms also comprise a hydraulic damper. However, this solution has the drawback that such hydraulic components are delicate and badly suited for outdoors use. They are more particularly quite sensitive to temperature variations and are also often subjected to leakage problems.

U.S. Pat. No. 4,872,239 tries to remedy these problems by converting the relative linear translational motion of the elongated push/pull member and the base part into a rotational motion and braking it by using a rotary braking device instead of the previous hydraulic dampers. However, the rotary braking device of this prior art is a friction brake of the type that generates a constant braking torque, irrespective of the rotational speed of its input and thus of the closing speed of the hinged closure member. Since the force generated by the resilient element increases linearly with the displacement from said first position, following Hooke's Law, and thus nearly linearly with the opening angle of the door, this has the drawback that an element resilient enough to still overcome the braking torque of the friction brake at small door opening angles may push the door too hard at large door opening angles, and makes the door difficult to properly open especially for children or older people. Furthermore, the hinged member will be accelerated during the whole closing movement, reaching its peak speed just as it closes, potentially leading to painful and dangerous injuries or material damage.

On the other hand, without an element resilient enough, the mechanism may stick, especially in an outdoors environment with significant temperature changes, dirt, rain, freezing weather and so on, leaving the door ajar, with potentially very negative consequences in security- or safety-critical applications, such as doors of enclosures of airports, swimming pools, etc. U.S. Pat. No. 4,872,239 tries to avoid these drawbacks by decoupling the friction brake at small opening angles, which in turn generates additional problems, such as a lack of damping at those small opening angles, without solving the problem of the hinged member's high final closing speed.

An object of the present invention is therefore that of providing a closure mechanism with a safe closing speed at and from all opening angles and a high degree of reliability, even for outdoor applications.

To this end, the closure mechanism according to the invention is characterised in that the rotary braking device is of the type that, when in use, brakes its input element with a variable braking torque which increases and decreases with the rotational speed of the input element of the rotary braking device, the rotary braking device preferably comprising a centrifugal brake.

In the closure mechanism according to the invention, the braking torque of the closure mechanism increases with the closing speed of the hinged member until braking torque and driving force of the resilient element reach a state of equilibrium and the closing speed stabilises. In this way, the invention ensures a safe closing speed at and from all opening angles without compromising the closing performance.

In other types of closure mechanisms it has also been proposed to use centrifugal brakes to provide a variable braking torque, for instance in U.S. Pat. No. 5,048,151 and in U.S. Pat. No. 4,912,806. These prior art mechanisms comprise also two parts which are respectively attached to the hinged member and to the structure onto which the hinged member is mounted but the two parts are pivotally connected to one another so that a varying distance between their attachment points to the hinged member and the structure is obtained by a relative rotational motion. One part is more particularly a lever arm so that the rotation of the closure member is converted in a corresponding rotation of the first gear wheel of the closure mechanism. In this way, when opening the closure member over an angle of 90°, the first gear wheel of the closure mechanism is also rotated only over a fraction of one rotation. A drawback of such mechanisms is that, since compact centrifugal brakes are only effective at high rotational speeds (for example above 1000 rpm), they need gear trains of considerable complexity to multiply the rotational motion of the door hinge within a limited amount of space. This is in direct conflict with the need to keep the mechanism compact. The closure mechanisms disclosed in U.S. Pat. No. 5,048,151 and in U.S. Pat. No. 4,912,806 both use, in the last stage of their gear trains, a worm shaft to achieve the necessary high speed-up ratio in a compact mechanism. Such worm shafts are, however, prone to blocking under heavy load, and thus not advisable for security- or safety-critical applications. This is especially the case for outdoor applications wherein the closure mechanism is subjected to various temperature and humidity conditions and wherein ice may even be formed within the mechanism.

British patent GB 190002775 also proposed a centrifugal brake for a door check, however without such a high speed-up ratio. Due to the low speed-up ratio or in other words due to the small centrifugal force, it appears that this door check would not work satisfactorily, despite special measures having been taken to try to achieve the required braking force. First of all it is clear that the frictional coefficient between the braking pads (weighted arms) and the braking surface has to be quite high to be able to produce the required braking torque. In GB 190002775 this is attempted by the use of leather. An essential feature of the door check disclosed in GB 190002775 is further that it comprises means for urging the braking pads away from the braking surface. The braking pads are in particular mounted on pivots that are inclined so that gravity tends to swing the braking pads away from the braking surface. It is clear that adjusting the weight of the braking pads, the inclination of their pivots and the frictional coefficient between the braking pads and the braking surface is quite delicate to achieve the desired braking effect. Moreover, the door check may become quite easily disordered when the frictional coefficient changes for example due to wear or to varying weather conditions (humidity, ice formation, temperature changes, etc.). It must also be noted that GB 190002775 concerns a door check that merely brakes external forces acting on the door, not a closure mechanism with a driving actuator.

In contrast to the mechanisms disclosed in U.S. Pat. No. 5,048,151, in U.S. Pat. No. 4,912,806 and in GB 190002775, an important additional speed-up stage is already achieved in the closure mechanism according to the present invention wherein the angular motion of the hinged member is first converted into a translational motion between the two parts of the closure mechanism, and then into a rotational motion of the rotary output element of the motion converting means. In this way, a smaller speed-up ratio has to be provided between this rotary output element and the rotary input element of the rotary braking device whilst maintaining the reliability and advantages of a centrifugal brake. It is more particularly possible to replace, in a closure mechanism as disclosed in U.S. Pat. No. 4,872,239 the disadvantageous friction brake by a centrifugal brake without having to add a lot of additional gear wheels and in particular without having to use a worm wheel transmission to keep the mechanism sufficiently compact.

Advantageously, the closure mechanism of the invention further comprises a transmission gearing comprising one or more stages increasing the rotational speed between the output element of the motion converting means and the input element of the rotary braking device. Increasing the rotational speed and reducing the torque at the rotary braking device, facilitates a progressive action of the rotary braking device while keeping it light and compact.

Advantageously, the closure mechanism of the invention further comprises a one-way clutch, preferably comprising a ratchet wheel, so as to enable rotation of said rotary output element of the motion converting means without rotating said rotary input element of the rotary braking device when the elongated push/pull member is moved towards the second position. The advantage of such an embodiment of the invention is to enable the user to open the hinged member without having to act against the rotary braking device of the closure mechanism.

In a particularly advantageous embodiment, at least one speed-up stage of the transmission gearing is placed between the one-way clutch and the input element of the rotary braking device. The advantage of this embodiment is to reduce the rotational speed of the one-way clutch so that it is less subjected to wear and produces less noise.

Also advantageously, the closure mechanism of the invention further comprises a torque limiter, preferably comprising a friction clutch set to slip at a predetermined torque, so as to limit the maximum torque transmitted between said rotary output element of the motion converting means and said rotary input element of the rotary braking device. The advantage of such an embodiment of the invention is to protect the closure mechanism from overloading if external forces are exerted on the hinged member to close it.

In a particularly advantageous embodiment, the torque limiter is contained within one gearwheel of the transmission gearing. This has the advantage of improved compactness.

In a particularly advantageous embodiment, at least one speed-up stage of the transmission gearing is placed between the output element of the motion converting means and the torque limiter. The advantage of such an embodiment is to reduce the torque at the torque limiter, thus enabling the use of smaller, lighter torque limiter.

Advantageously, the motion converting means comprises a rack-and-pinion gear. This has the advantage of cheapness and simplicity whilst being very reliable. Preferably, the rack is formed on or attached to the elongated push/pull member.

Advantageously, the resilient element is a coil spring, which provides strength and reliability.

Advantageously, the closure mechanism of the invention also comprises a pivot device mounted on a base element of the elongated push/pull member or the base part for pivotally attaching said elongated push/pull member or base part to the hinged member or structure, the pivot device being mounted so that it can rotate on the base element around a first axis substantially different to a second axis on which it is pivotally attachable to the hinged member or structure, the first axis being preferably substantially perpendicular to the second axis. In this way, the closure mechanism adapts itself to various angles of attachment to the hinged member or structure and is protected from potential damage resulting from misalignment of the pivots.

In an alternative, advantageous embodiment, said elongated push/pull member comprises a bendable member comprising a semi-flexible chain, said semi-flexible chain comprising a plurality of links, each one of these links being pivotally attached to at least one other link with a limited pivoting angle, so that said chain can transmit push and pull forces but is limitedly bendable. This has the advantage of providing a particularly compact closure mechanism that can be integrated in the hinged member.

Although compact closure mechanisms using chains have been previously disclosed, for instance in GB 1,044,911, DE 43 08 181 or GB 2 016 583, these disclosed mechanisms have the drawback that, since their chains are fully flexible, they could not brake a hinged member being closed by external forces. Indeed, if the hinged member was slammed closed, it could eventually catch the slack chain, which could result in serious damage. Since the chain of this embodiment is of the type that is only limitedly bendable and suitable to transmit push as well as pull forces, it can be used in the closure mechanism of the invention. None of the cited prior art closure mechanisms with chains comprise a brake.

Particularly advantageously, said semi-flexible chain has a minimum bending radius in both directions of at least 100 mm, preferably at least 120 mm. This seems the most suitable minimum bending radius for closure mechanisms for gates.

The invention will be described in detail and non-limitingly with reference to the accompanying figures, in which:

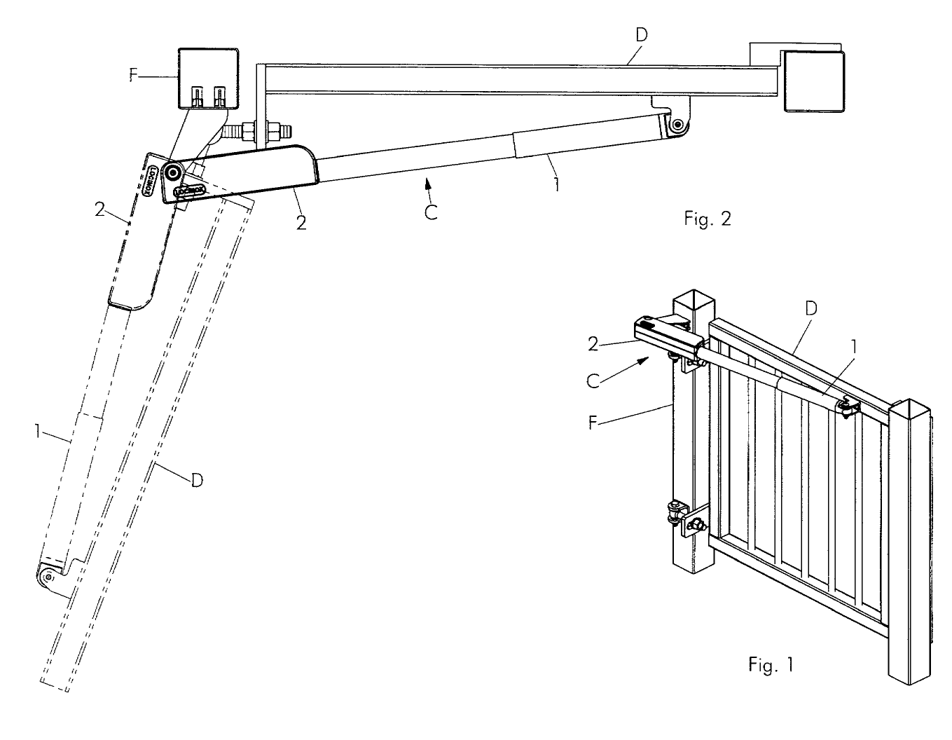

FIGS. 1 and 2 represent a hinged door with a closure mechanism according to the invention;

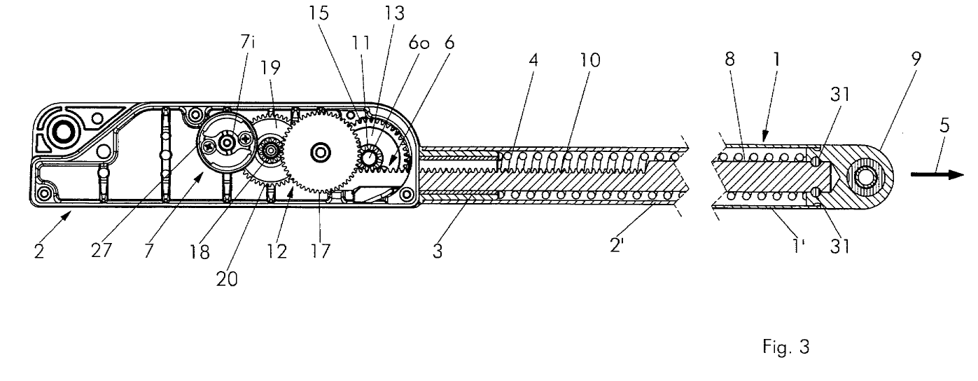

FIG. 3 represents an embodiment of the closure mechanism according to the invention during a normal closing operation in which the elongated push/pull member moves away from the base part, i.e. towards its first position;

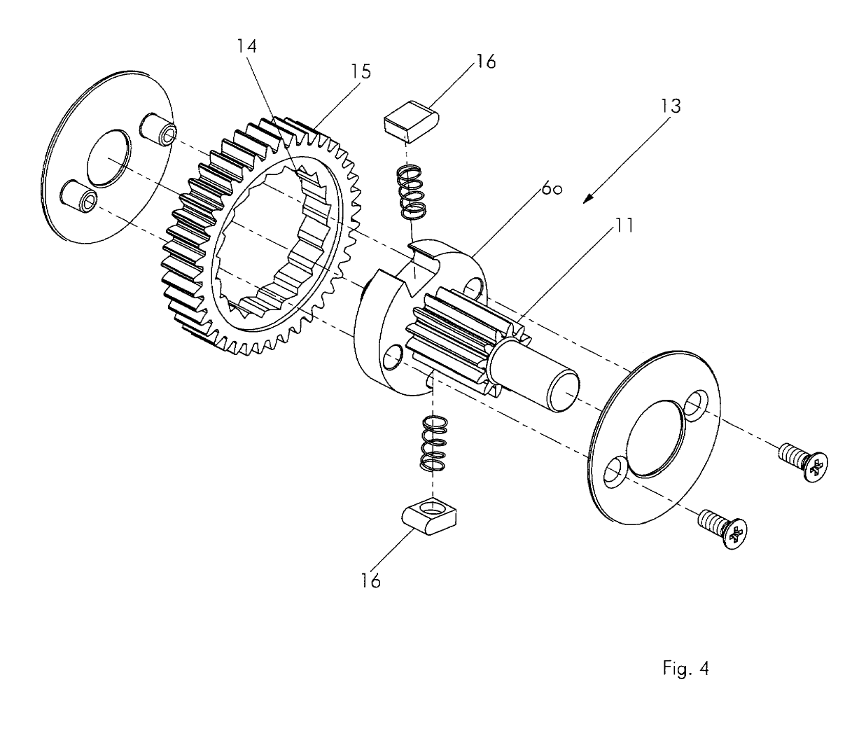

FIG. 4 is an exploded, perspective view of the one-way clutch of said embodiment;

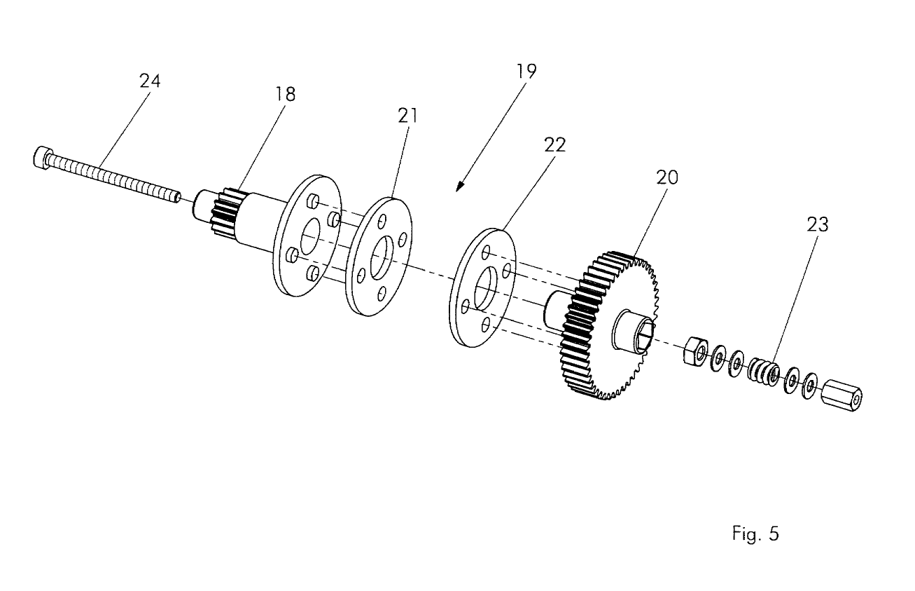

FIG. 5 is an exploded, perspective view of the torque limiter of said embodiment;

FIG. 6 is an exploded, perspective view of a centrifugal brake of said embodiment;

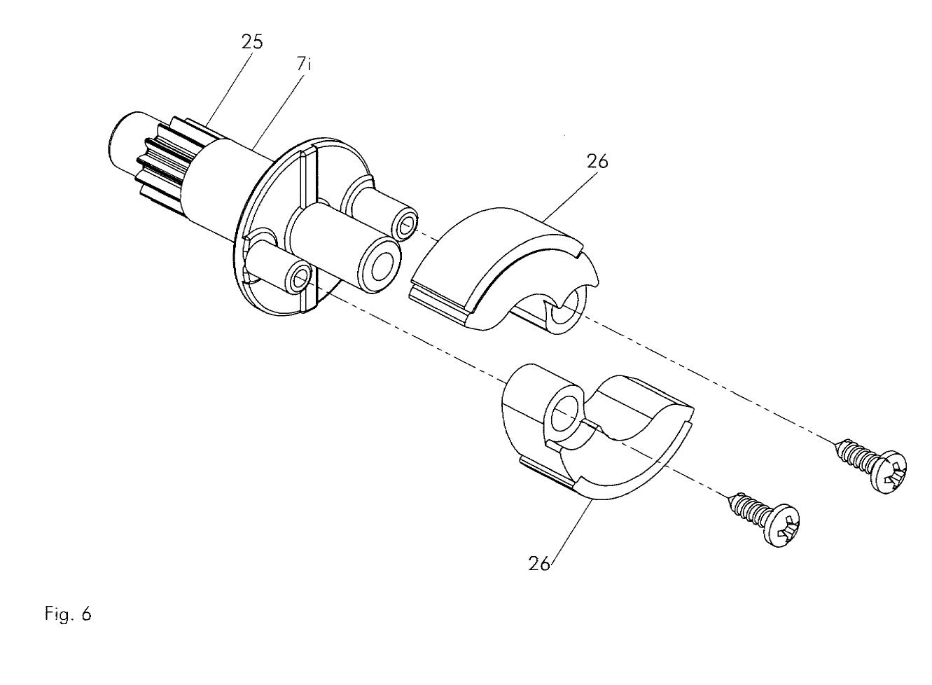

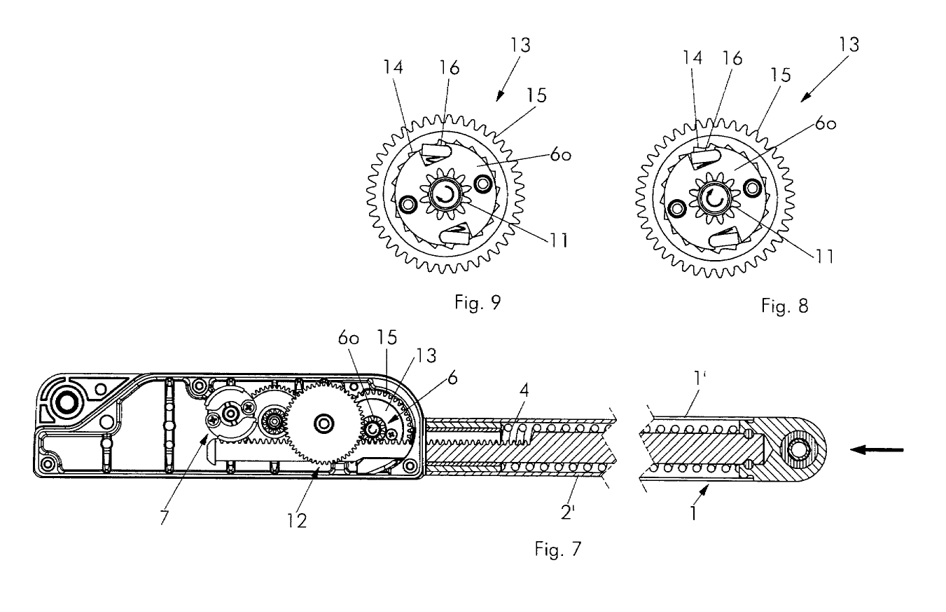

FIG. 7 represents the same embodiment of the closure mechanism during an opening operation;

FIGS. 8 and 9 are detail views of the one-way clutch of said embodiment, as the output element of the motion converting means is rotated in opposite directions;

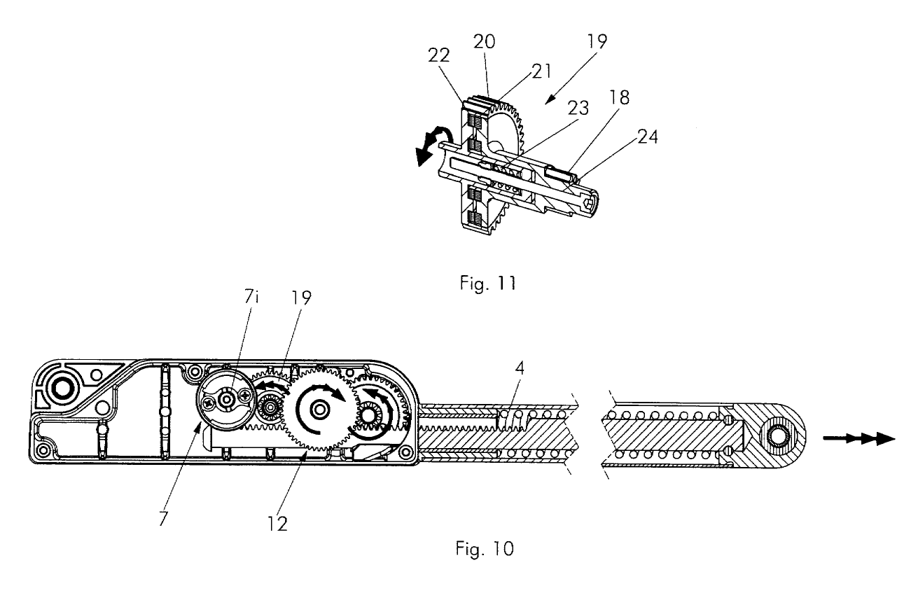

FIG. 10 represents the same embodiment during a closing operation accelerated by an external force;

FIG. 11 is a detail view of the torque limiter during the same operation and

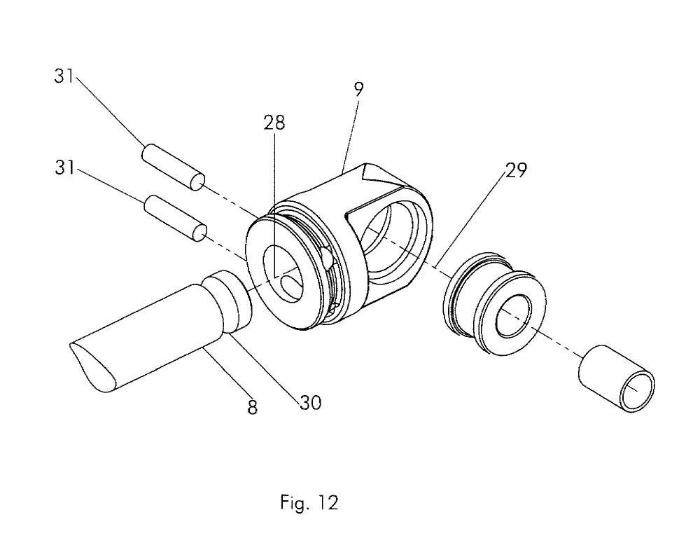

FIG. 12 is an exploded, perspective view of the pivot device of said embodiment.

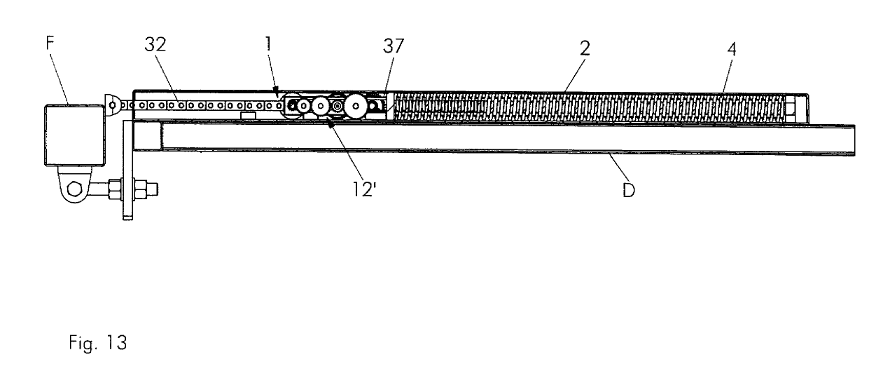

FIG. 13 represents a hinged door, in a closed position, with an alternative embodiment of the closure mechanism;

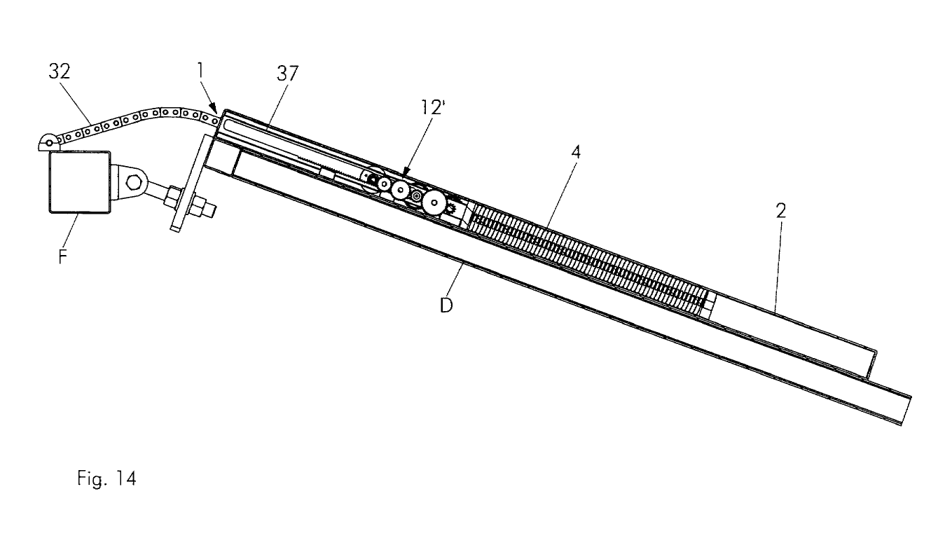

FIG. 14 represents the same hinged door, in an open position, with said alternative embodiment of the closure mechanism;

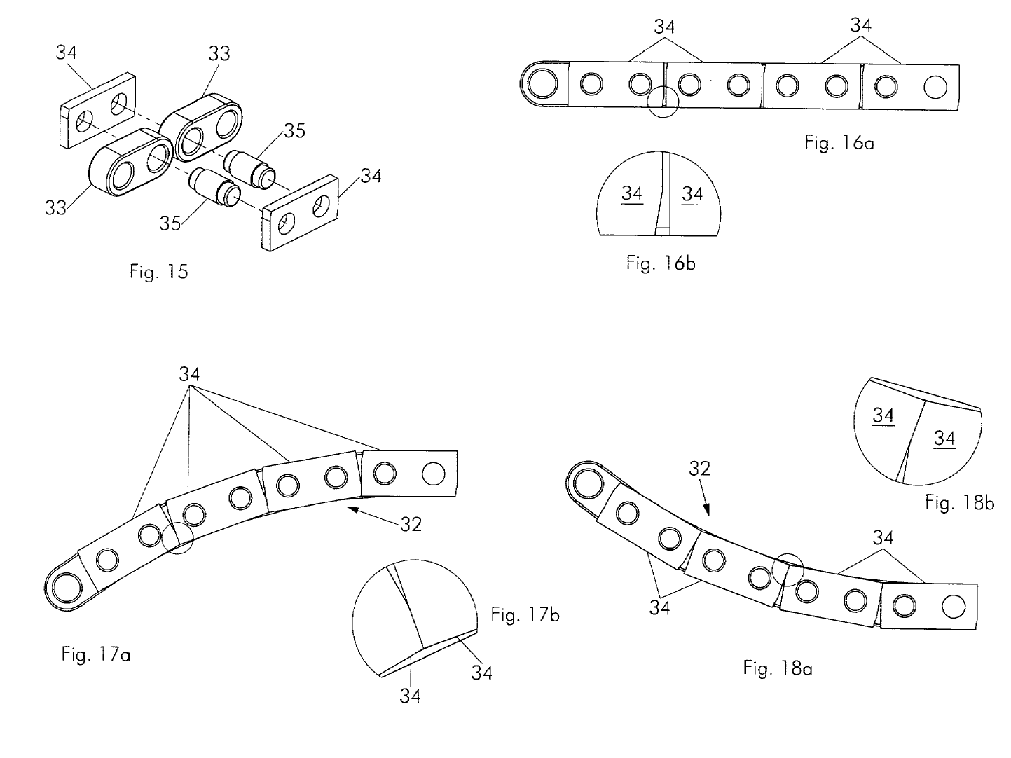

FIG. 15 is an exploded view of two links of a semi-flexible chain of said alternative embodiment;

FIG. 16a represents a straight length of said chain;

FIG. 16b is a corresponding detail view;

FIG. 17a represents a length of said chain bent to one side;

FIG. 17b is a corresponding detail view;

FIG. 18a represents a length of said chain bent to the opposite side;

FIG. 18b is a corresponding detail view; and

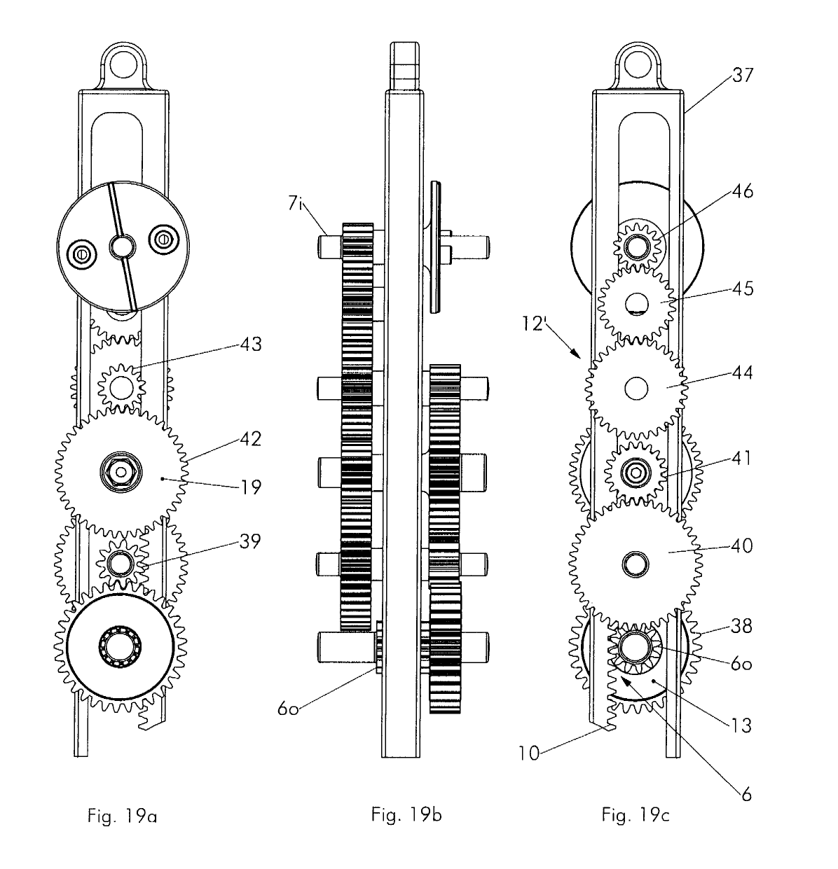

FIGS. 19a, 19b and 19c are three views from a transmission gearing in said alternative embodiment of the invention.

FIGS. 1 and 2 depict a closure member D, in this example a door leaf or garden gate, hinged to a structure F, in this example a post. Between the door leaf D and the post F, a compact closure mechanism C according to the invention, is installed which comprises an elongated push/pull member 1 which is pivotally attached to the hinged door leaf D, and a base part 2 which is pivotally attached to the door frame F. In FIG. 2 the door leaf D and closure mechanism C are represented both in the open and closed position. When the door is opened, the elongated push/pull member 1 and the base part 2 move towards each other in a relative translational motion. To close the door, the elongated push/pull member 1 and the base part 2 are urged apart, thus pushing the door leaf D back towards the closed position wherein the elongated push/pull member 1 is in its first or extended position with respect to the base part 2.

Referring now to FIG. 3, the closure mechanism C is illustrated more into detail. The elongated push/pull member 1 comprises a sleeve 1′ which is telescopically slidable over a corresponding sleeve 2′ of the base part 2, so as to guide the elongated push/pull member 1 between its first position, wherein the door is closed, and a second position in a linear translational motion relative to the base part 2. The closure mechanism C is mounted preferably in such a manner on the closure member D and on the structure F that, when opening the closure member D over an angle of 90°, the elongated push/pull member 1 moves over a distance of at least 100 mm, preferably over a distance of at least 120 mm with respect to the base part 2. In the example illustrated in the figures, the elongated push/pull member 1 moves over a distance of about 140 mm with respect to the base part. In addition to the elongated push/pull element 1 and the base part 2, the closure mechanism C also comprises means, including, for example, a plastic sliding bearing 3, for holding the elongated push/pull member 1 and the base part 2 together.

The closure mechanism C also comprises a resilient element 4 placed between the elongated push/pull member 1 and base parts 1, 2 so as to urge the elongated push/pull member 1 in the direction 5 of the linear translational motion towards its first position, i.e. towards the position wherein the closure member is closed. In order to be able to control the closing speed, the closure mechanism C further comprises a motion converting device 6 for converting the linear translational motion of said elongated push/pull member 1 relative to said base part 2 into a rotational motion of an output element 6o of said converting means 6, and a rotary braking device 7 which comprises an input element 7i coupled directly or indirectly to the output element 6o of the motion converting device 6 and arranged to be braked at least when the elongated push/pull member 1 moves towards its first position, i.e. when the closure member is closed by means of the resilient element 4.

In the illustrated embodiment, the elongated push/pull member 1 comprises a base element 8, in the form of a cylindrical rod, and a pivot device 9 which can pivot with respect to this rod. The base part 2 has the form of a housing containing i.a. the motion converting device 6 and the rotary braking device 7. The resilient element 4 is embodied in a coil spring, which surrounds the base element 8 and is itself housed in the two telescoping sleeves 1′ and 2′, so as to be guided therein and protected from the outside environment. In the illustrated embodiment, the converting means 6 comprises a rack-and-pinion gear, with the rack 10 formed on the base element 8 of the elongated push/pull member 1 and a 12-teeth pinion 11 on the output element 6o of the motion converting means 6. When opening the closure member over 90°, the rack is displaced over about 140 mm and the pinion 11 makes about 4 rotations. The motion converting means 6 could be of a different type, such as a ball screw, but the depicted rack-and-pinion gear has the advantages of cheapness, simplicity and reliability. There are also alternatives to the coil spring as the resilient element 4, such as air and elastomeric springs, but the coil spring also appears to be particularly advantageous for this invention.

In the illustrated embodiment, the rotary output element 6o of the motion converting means 6 is coupled, in the depicted normal closing operation, to the input element 7i of the rotary braking device 7 through a transmission gearing 12 comprising three stages increasing the rotational speed between the output element 6o of the motion converting means 6 and the input element 7i of the rotary braking device 7. In the depicted embodiment, the transmission gearing 12 is a gearwheel train.

A significant advantage of the invention is that, since it does not require a high speed-up ratio between the output element 6o of the motion converting means 6 and the input element 7i of the rotary braking device 7, it allows the use of a simple transmission gearing 12, having at most five speed-up stages, and preferably at most three, as in this example wherein the transmission gearing 12 comprises three speed-up stages, each stage having individual speed-up ratios under 6 and preferably under 5 and gearwheels smaller than 8 cm in diameter, and preferably under 6 cm, so that the mechanism can be kept quite compact. The total speed-up ratio of the transmission gearing 12 can be less than 80, preferably less than 60. However, it would be advantageous to have a speed-up ratio of more than 15, and preferably more than 25. As will appear from the following description, the total speed-up ratio of the transmission gearing illustrated in the figures is about 43.7.

In the depicted embodiment, a one way-clutch 13 is placed between the output element 60 of the motion converting means 6 and the transmission gearing 12. This one-way clutch 13, as can be seen in FIG. 4, essentially consists in a ratchet-wheel 14 formed on the inside of a first gearwheel 15 of the transmission gearing 12, and two pawls 16, resiliently mounted on the output element 60 of the motion converting means 6, so as to engage with the ratchet wheel 14 only when the output element 6o rotates in one direction.

Turning back to FIG. 3, the first gearwheel 15, having 40 teeth, engages a second pinion (not illustrated but having 12 teeth), formed on the same axle as a second gearwheel 17, which has 52 teeth and engages a third pinion 18 having 14 teeth.

In the depicted embodiment, this third pinion 18 is coupled to a torque limiter 19 in the form of a friction clutch interposed between the third pinion 18 and a third gearwheel 20 (which has 46 teeth).

As can be seen in FIG. 5, the torque limiter 19 comprises a first friction disc 21, mounted so as to rotate with the third pinion 18, and a second friction disc 22, mounted so as to rotate with the third gearwheel 20. The first and second friction discs 21, 22 are pushed together by a clutch spring 23 with a force that can be calibrated with a calibrating screw 24. The maximum torque of the torque limiter 19 will depend on that force and the friction coefficient between the two friction discs 21, 22. In the illustrated embodiment, one of the friction discs 21 or 22 is made of stainless steel, whereas the other friction disc 21 or 22 is made of a friction material of the type used in brake pads, so that the friction coefficient between the two friction discs 21, 22 remains substantially constant, regardless of temperature or humidity. A friction coefficient of at least 0.3 and preferably at least 0.35 allows the use of a small clutch spring 23, thus contributing to the compactness of the closure mechanism C. In the illustrated embodiment, the torque limiter 19 is contained within the third gearwheel 20, in an arrangement particularly advantageous for the purpose of obtaining a compact closure mechanism C.

Finally, the third gearwheel 20 engages a fourth pinion 25 (not illustrated in FIG. 3 but having 13 teeth) formed on the rotary input element 7i of the rotary braking device 7. As can be seen in FIG. 6, the rotary braking device 7 of this embodiment comprises essentially two braking pads 26 eccentrically hinged to the input element 7i of the rotary braking device 7, so as to be urged against a braking surface 27 (not illustrated in FIG. 6) surrounding them, with a centrifugal force proportional to the square of the rotational speed of the input element 7i of the rotary braking device 7.

Alternatives to the centrifugal brake of this embodiment, such as a rotary hydrodynamic brake, can be considered, as long as they also generate a variable braking torque which increases and decreases with the rotational speed of the input element 7i of the rotary braking device 7.

Turning back to FIG. 3, during the normal closing operation, the elongated push/pull member 1 moves, urged by the resilient element 4, in the direction 5 towards its first position in which the hinged member D will be closed. The linear translational motion of the elongated push/pull member 1 relative to the base part 2 is converted by the motion converting means 6 into a rotational motion of the output element 6o of said motion converting means 6. In the illustrated embodiment, an angular motion of 90° by the hinged member D will be converted, through the linear translational motion of the elongated push/pull member 1 relative to the base part 2 and the motion converting means 6, into about four full revolutions of the output element 6o of said motion converting means 6. This rotational motion is transmitted through the speed-up stages of the transmission gearing 12 to the input element 7i of the rotary braking device 7. As the elongated push/pull member 1 is accelerated by the driving force of the resilient element 7 towards the first position, the rotational speed of the input element 7i of the rotary braking device 7 also increases. As the rotational speed of the input element 7i increases, so will the braking torque generated by the centrifugal brake in the rotary braking device 7, until it compensates the driving force of the resilient element 4. As the braking torque balances out the driving force of the resilient element 4, the elongated push/pull member 1 and therefore the hinged member will cease to accelerate. A state of equilibrium will be reached in which the braking torque and the driving force cancel each other until the elongated push/pull member 1 reaches first position is reached and/or the hinged member closes. In practice, the closure member may close in about 4 seconds. With the motion converting means 6 and the transmission gearing 12 illustrated in the figures, this corresponds to a rotational speed of the input element 7i of the centrifugal brake 7 of about 2600 rpm, thus enabling an effective braking action even when the centrifugal brake 7 has limited dimensions (inner diameter of the braking surface smaller than 7 cm and preferably smaller than 5 cm) to fit in a compact closure mechanism.

Turning now to FIGS. 7 to 9, the operation of this closure mechanism C during an opening motion of the hinged member will be explained. Should the elongated push/pull member 1 remain coupled to the rotary braking device 7 during this opening motion, a braking torque would be generated which would add to the resistance of the resilient member 4 to the opening motion. The one-way clutch 13 therefore has the purpose of letting the output element 6o of the motion converting means 6 freewheel during this opening motion, as depicted in FIGS. 7 and 8, so that its rotational motion is not transmitted to the gearwheel 15. On the other hand, during a closing motion, the pawls 16 engage the ratchet wheel 14, and the one-way clutch 13 transmits the rotational motion of the output element 6o to the gearwheel 15, as depicted in FIG. 9.

Coupling the one-way clutch 13 directly to the output element 6o of the motion converting means has the advantage that, before the speed-up stages of the transmission gearing 12, the rotational speed is still moderate, and such one-way clutches perform more reliably at moderate rotational speeds. Other arrangements of ratchet wheels, as well as alternative types of one-way clutches, as known by the skilled person, could alternatively be used.

Turning now to FIGS. 10 and 11, the operation of this closure mechanism C during an accelerated closing motion of the hinged member in which the driving force of the resilient element 4 is significantly reinforced by external forces, such as those exerted by a user, the wind, etc. will be illustrated. During such a motion, the braking torque generated by the rotary braking device 7 and the rotational speed of the input element 7i of the rotary braking device 7 could increase so much that the closure mechanism could be overloaded and damaged. The torque limiter 19 therefore has the purpose of limiting the maximum torque that can be transmitted between the motion converting means 6 and the rotary braking device 7 in such a situation to prevent an overload. As can be seen in FIGS. 10 and 11, if the maximum torque is reached, the friction discs 21, 22 will slip. Placing the torque limiter 19 behind one or several speed-up stages of the transmission gearing 12, as in this embodiment, has the advantage that there the torques are lower, so that the torque limiter 19 does not need to be dimensioned for heavy loads.

Turning now to FIG. 12, the pivot device 9 of the elongated push/pull member 1 is illustrated in detail. The pivot device 9 is mounted on the base element 8, i.e. onto the rod, so that it can rotate on said base element 8 around a first axis 28 perpendicular to a second axis 29 on which the pivot device 9 is pivotally attached to the hinged member D. In this case the first axis 28 is the axis of the linear translational motion of the elongated push/pull member 1 relative to the base part 2. The purpose of the rotational mounting of the pivot device 9 is to enable the closure mechanism C to be adapted to various angles of attachment to the hinged member D or structure F, while ensuring that the rack-and-pinion motion converting means 6 is not submitted to damaging torsion loads.

For this purpose, the cylindrical rod forming the base element 8 comprises a circumferential notch 30 near the end of the base element 8 distal to the base part 2. The pivot device 9 in turn comprises at least one pin 31, preferably two, slotting into said circumferential notch 30 so as to restrain the pivot device 9 axially, while allowing its rotation around base element 8.

An alternative embodiment of the present invention is schematically represented in FIGS. 13 to 19c. In this alternative embodiment the elongated push/pull member 1 comprises a semi-flexible chain 32. Said semi-flexible chain 32 is made up of a set of successively pivotally linked links 33. In this embodiment, as illustrated in FIG. 15, each link 33 is pivotally linked to the next link 33 by two plates 34 holding two barrels 35 between them, each of the barrels 35 being inserted through a cylindrical hole 36 in one of the links 33. As can be seen in FIGS. 17a, 17b, 18a and 18b, the plates 34 limit by their shape the pivoting angle to each side of each link 33 relative to the next link 33 so that said chain 32 can transmit not only pull forces, but also push forces. Due to the limited pivoting angle of each link 33 with respect to the next link 33, the semi-flexible chain 32 has a minimum bending radius in both directions of at least 100 mm, preferably at least 120 mm. In the illustrated embodiment, the maximum pivoting angle of each link 33 with respect to the next link 33 is 10° and the minimum bending radius of the chain 32 143 mm.

Although in this particular embodiment the pivoting angle of each link 33 with respect to the next link 33 is limited by the shape of the plates 34, alternative designs of similarly semi-flexible chains could be used instead. The pivoting angle of each link 33 with respect to the next link 33 could be limited, for example, by protrusions and/or notches in each link 33.

Because of the flexibility in bending of the semi-flexible chain 32, the base part 2 in the embodiment shown in FIGS. 13 to 18 can be directly and non-pivotally attached to the hinged member D, and preferably integrated into it, allowing a significant saving in space and a more harmonious appearance. In this embodiment, the elongated push/pull member 1 also comprises a rigid element 37, which is guided in a translational motion between a first and a second position in a linear translational motion relative to the second part 2. The rigid element 37 is urged towards said first position by resilient means 4 in the form of a coil compression spring. In this embodiment, the closure mechanism C is in its extended state when the hinged member D is open and in its retracted state when the hinged member D is closed.

Turning now to FIGS. 19a, 19b and 19c, the rack 10 of a rack-and-pinion gear is also formed on said rigid element 37. Said rack-and-pinion gear forms part of a motion converting means 6, comprising a rotary output element 6o, for converting the translational motion of said rigid element 37 of said elongated push/pull member 1 relative to said base part 2 into a rotational motion of said rotary output element 6o. Similarly as in the previously described embodiment, said rotational motion can be transmitted to a rotary input element 7i of a rotary braking device (not illustrated in these figures, but analogous to that of the previously described element) through a speed increasing transmission gearing 12′.

The speed increasing transmission gearing 12′ of this second embodiment differs from that of the first embodiment in comprising gearwheels with smaller diameters in order to achieve a more compact closure mechanism C eventually suitable for being integrated into the hinged member D. In order to maintain a similar overall speed-up ratio, the speed increasing transmission gearing 12′ therefore comprises additional gearwheels and speed-increasing stages. Parts identical to those of the first embodiment, such as the one-way clutch 13 or the torque limiter 19 are given the same reference numbers in these figures and will not be discussed in detail.

In this second embodiment, a one way-clutch 13 is also placed between the output element 6o of the motion converting means 6 and the first gearwheel 38 of the transmission gearing 12′. The first gearwheel 38, having here 33 teeth, engages a second pinion 39, that has 11 teeth and is formed on the same axle as a second gearwheel 40, which has 42 teeth and engages a third pinion 41 having 19 teeth.

In this second embodiment, this third pinion 41 is also coupled to a torque limiter 19 in the form of a friction clutch interposed between the third pinion 41 and a third gearwheel 42 (which has 42 teeth). The third gearwheel 42 engages a fourth pinion 43 (having 14 teeth) formed on the same axle as a fourth gearwheel 44 having 32 teeth. The fourth gearwheel 44 engages a fifth gearwheel 45 (having 24 teeth), which in turn engages a fifth pinion 46 having 14 teeth and formed on the rotary input element 7i.

Although the present invention has been described with reference to specific exemplary embodiments, it will be evident that various modifications and changes may be made to these embodiments without departing from the broader scope of the invention as set forth in the claims. Accordingly, the description and drawings are to be regarded in an illustrative sense rather than a restrictive sense.

1. A closure mechanism (C) for a member (D) hinged to a structure (F), comprising
an elongated push/pull member (1), comprising a bendable and/or pivotal element for attachment to one of said hinged member (D) or structure (F);
a base part (2), substantially rigid and attachable to the other one of said hinged member (D) or structure (F), the elongated push/pull member (1) and the base part (2) being assembled to each other so that said elongated push/pull member (1) is guided in a translational motion relative to the base part (2) between a first and a second position;
a resilient element (4) placed between said first and base parts (1, 2) so as to urge the elongated push/pull member (1) towards said first position;
a motion converting means (6), comprising a rotary output element (6o), for converting the translational motion of said elongated push/pull member (1) relative to said base part (2) into a rotational motion of said rotary output element (60); and
a rotary braking device (7) comprising a rotary input element (7i) directly or indirectly coupled to said rotary output element (6o) at least during movement of the elongated push/pull member (1) towards said first position, so as to be rotated thereby;
the closure mechanism (C) being characterised in that the rotary braking device (7) is of the type that, when in operation, brakes its rotary input element (7i) with a variable braking torque which increases and decreases with the rotational speed of said rotary input element (7i).

2. A closure mechanism (C) according to claim 1, wherein the rotary braking device (7) comprises a centrifugal brake, so as to generate said variable braking torque.

3. A closure mechanism (C) according to claim 1, further comprising a speed increasing transmission gearing (12,12′) interposed between the rotary output element (6o) of the motion converting means (6) and the rotary input element (7i) of the rotary braking device (7), which transmission gearing (12) comprises one or more speed-increasing stages increasing the rotational speed between the output element (6o) of the motion converting means (6) and the input element (7i) of the rotary braking means (7).

4. A closure mechanism (C) according to claim 3, wherein said transmission gearing (12,12′) comprises at most 5, preferably at most 3 speed-increasing stages.

5. A closure mechanism (C) according to claim 3, wherein each speed-increasing stage of the transmission gearing (12,12′) has a speed-up ratio of less than 6, preferably less than 5.

6. A closure mechanism (C) according to claim 3, wherein the transmission gearing (12,12′) is a gear wheel train composed of gear wheels (15,17,20), all of which have an outer diameter of less than 8 cm, preferably less than 6 cm.

7. A closure mechanism (C) according to claim 3, wherein the speed-up ratio between the output element (6o) of the motion converting means (6) and the input element (7i) of the rotary braking device (7) is less than 80 and preferably less than 60.

8. A closure mechanism (C) according to claim 3, wherein the speed-up ratio between the output element (6o) of the motion converting means (6) and the input element (7i) of the rotary braking device (7) is more than 15 and preferably more than 25.

9. A closure mechanism (C) according to claim 3, further comprising a one-way clutch (13), preferably comprising a ratchet wheel (14), which one-way clutch (13) is interposed between the rotary output element (6o) of the motion converting means (6) and the rotary input element (7i) of the rotary braking device (7) to enable rotation of said rotary output element (6o) without rotating said rotary input element (7i) when the elongated push/pull member (1) is moved towards the second position, at least one speed-increasing stage of said speed-increasing transmission gearing (12,12′) being placed between the one-way clutch (13) and the input element (7i) of the rotary braking device (7).

10. A closure mechanism (C) according to claim 3, further comprising a torque limiter (19) interposed between the rotary output element (6o) of the motion converting means (6) and the rotary input element (7i) of the rotary braking device (7), so as to limit the maximum torque transmitted between said rotary output element (6o) and said rotary input element (7i), which torque limiter (19) preferably comprises a friction clutch set to slip at a predetermined torque, wherein at least one speed-increasing stage of the transmission gearing (12) is placed between the output element (6o) of the motion converting means (6) and the torque limiter (19).

11. A closure mechanism (C) according to claim 3, further comprising a torque limiter (19) interposed between the rotary output element (6o) of the motion converting means (6) and the rotary input element (7i) of the rotary braking device (7), so as to limit the maximum torque transmitted between said rotary output element (6o) and said rotary input element (7i), which torque limiter (19) is contained within a gearwheel (20) of the transmission gearing (12,12′), and preferably comprises a friction clutch comprising two opposed friction discs (21,22) set to slip at a predetermined torque.

12. A closure mechanism (C) according to claim 1, further comprising a torque limiter (19) interposed between the rotary output element (6o) of the motion converting means (6) and the rotary input element (7i) of the rotary braking device (7), so as to limit the maximum torque transmitted between said rotary output element (6o) and said rotary input element (7i), which torque limiter (19) preferably comprises a friction clutch set to slip at a predetermined torque.

13. A closure mechanism (C) according to claim 12, further comprising a one-way clutch (13), preferably comprising a ratchet wheel (14), which one-way clutch (13) is interposed between the rotary output element (6o) of the motion converting means (6) and the rotary input element (7i) of the rotary braking device (7) to enable rotation of said rotary output element (6o) without rotating said rotary input element (7i) when the elongated push/pull member (1) is moved towards said second position.

14. A closure mechanism (C) according to claim 1, wherein the motion converting means (6) comprises a rack-and-pinion gear, wherein the rack is preferably formed on or attached to the elongated push/pull member (1).

15. A closure mechanism (C) according to claim 1, wherein the elongated push/pull member (1) comprises a sleeve (1′) and the base part (2) comprises another sleeve (2′) and one of the sleeves (1′, 2′) is telescopically slidable over the other sleeve (1′, 2′) during the translational movement of the elongated push/pull member (1) relative to the base part (2).

16. A closure mechanism (C) according to claim 15, wherein at least one of the two sleeves (1′, 2′) surrounds the resilient element (4).

17. A closure mechanism (C) according to claim 1, wherein the resilient element (4) comprises a coil spring.

18. A closure mechanism according to claim 1, wherein the distance between said first position and said second position is at least 100 mm, preferably at least 120 mm.

19. A closure mechanism (C) according to claim 1, comprising a pivot device (9) mounted on a base element (8) of the elongated push/pull member (1) or base part (2) for pivotally attaching said elongated push/pull member (1) or base part (2) to the hinged member (D) or structure (F), wherein the pivot device (9) is mounted so that it can rotate on the base element (8) around a first axis (28) substantially different to a second axis (29) on which it is pivotally attachable to the hinged member (D) or structure (F), the first axis (28) being in particular substantially perpendicular to the second axis (29).

20. A closure mechanism (C) according to claim 1, wherein said bendable and/or pivotal element comprises a semi-flexible chain (32), said semi-flexible chain (32) comprising a plurality of links (33), each one of these links (33) being pivotally attached to at least one other link (33) with a limited pivoting angle, so that said chain (32) can transmit push and pull forces but is limitedly bendable.

21. A closure mechanism (C) according to claim 20, wherein said semi-flexible chain (32) has a minimum bending radius in both directions of at least 100 mm, preferably at least 120 mm.

22. A hinged closure member, in particular a hinged door, gate or window, which closure member is provided with a closure mechanism (C) according to claim 1.

23. A closure mechanism (C) according to claim 1, further comprising a one-way clutch (13), preferably comprising a ratchet wheel (14), which one-way clutch (13) is interposed between the rotary output element (6o) of the motion converting means (6) and the rotary input element (7i) of the rotary braking device (7) to enable rotation of said rotary output element (6o) without rotating said rotary input element (7i) when the elongated push/pull member (1) is moved towards said second position.
